(19) United States
(12) Patent Application Publication
(10) Pub. No.: US 2009/0166406 A1
(43) Pub. Date: Jul. 2, 2009

(54) Instant Funds Availability Notification and Fraud Detection

(75) Inventors: Charles Pigg, Dallas, TX (US); Jared Rorrer, Charlotte, NC (US); David Barnhardt, Huntersville, NC (US); Janice Hernandez, Jacksonville, FL (US); Donald Binns, Charlotte, NC (US)

Correspondence Address: BANNER & WITCOFF, LTD;ATTORNEYS FOR CLIENT NUMBER 007131, 10 SOUTH WACKER DR., SUITE 3000, CHICAGO, IL, 60606, US

(73) Assignee: Bank of America Corporation, Charlotte, NC (US)

(21) Appl. No.: 11/967,816

(22) Filed: Dec. 31, 2007

(51) Int. Cl. G06Q 40/00

(52) U.S. Cl. 235/379

(57) ABSTRACT

Various aspects are directed to systems and processes for providing instant funds availability notification and/or real-time fraud detection in connection with a check image deposit, such as a check deposit at an image automated teller machine (ATM). The customer may, for instance, receive the notification on an ATM display and/or on a paper receipt printed by the ATM.

### BACKGROUND

Customers presently have two options for depositing a paper check at a bank. Customers can either deposit the check before a live human bank teller during business hours, or they can deposit the check at an automated teller machine (ATM), usually twenty-four hours a day, seven days a week. In either case, a funds availability hold may be placed on the check deposit. An indication of whether or not the hold is placed, and for how long, is always provided to the customer. However, the timing of the notification depends on whether the check is deposited at an ATM or before a human teller.

Where the check is deposited before a human teller, the hold notification is typically provided in real time during the check deposit transaction. However, when the check is deposited at an ATM, the hold notification is not normally provided until some time after the ATM transaction has occurred, often several days after the ATM transaction. This is because normally the checks are collected periodically (e.g., once or twice per day) and later batch processed by the bank, at which time funds availability is determined. This delayed hold notification is typically provided by U.S. mail or by some other means for contacting the customer who is no longer in front of the ATM. In some cases, ATMs have the ability to optically scan the checks. In those cases, rather than waiting for the physical paper checks to be collected, the ATMs periodically send a batch of check images to the bank for processing. In either case, the hold notification is only provided to the customer after the ATM transaction is complete.

This hold notification is very useful to the customer. Without knowing the length of the hold being placed, the customer may later unintentionally over-withdraw from his or her account due to the funds not yet being fully available at the time of withdrawal. Or, a criminally-minded customer may, for instance, commit fraud against the bank by immediately withdrawing funds on a bad check deposited at the ATM, knowing that such deposits have not yet been reviewed for fraud or other problems.

### SUMMARY

Various aspects as described herein are directed to systems and processes for providing instant funds availability notification in connection with check image deposits, such as those made at the automated teller machine (ATM), during the image deposit transaction. The customer may receive the notification at, for instance, an ATM display and/or on a paper receipt printed by the ATM. In this way, the customer's experience at the ATM or other image deposit location may more closely match the experience of depositing a check before a live human bank teller.

Providing such instant hold notifications may further reduce the frequency of successful fraud, by allowing for at least an initial fraud review to be performed in real time during the image deposit transaction. Thus, another illustrative aspect is directed to the ability to perform real-time item-level risk assessment based on check images and/or other information provided by the ATM or other image deposit device used by the customer, during the image deposit transaction.

These and other aspects of the disclosure will be apparent upon consideration of the following detailed description of illustrative aspects.

### BRIEF DESCRIPTION OF THE DRAWINGS

A more complete understanding of the present disclosure may be acquired by referring to the following description in consideration of the accompanying drawings, in which like reference numbers indicate like features, and wherein:

FIG. 1 is a functional block diagram of an illustrative automated teller machine (ATM) having optical check scanning functionality, also referred to herein as an image ATM.

FIG. 2 is a functional block diagram of an illustrative system including the image ATM of FIG. 1 and other units involved in fraud detection and hold time determination.

FIGS. 3 and 4 together show a flow chart of illustrative steps that may be performed by a system such as the system of FIG. 2.

### DETAILED DESCRIPTION

The various aspects summarized previously may be embodied in various forms. The following description shows by way of illustration various examples in which the aspects may be practiced. It is understood that other examples may be utilized, and that structural and functional modifications may be made, without departing from the scope of the present disclosure.

Except where explicitly stated otherwise, all references herein to two or more elements being “coupled” to each other are intended to broadly include both (a) the elements being directly connected to each other, or otherwise in direct communication with each other, without any intervening elements, as well as (b) the elements being indirectly connected to each other, or otherwise in indirect communication with each other, with one or more intervening elements. Also, all communications between elements may be bidirectional or unidirectional as desired unless explicitly stated otherwise.

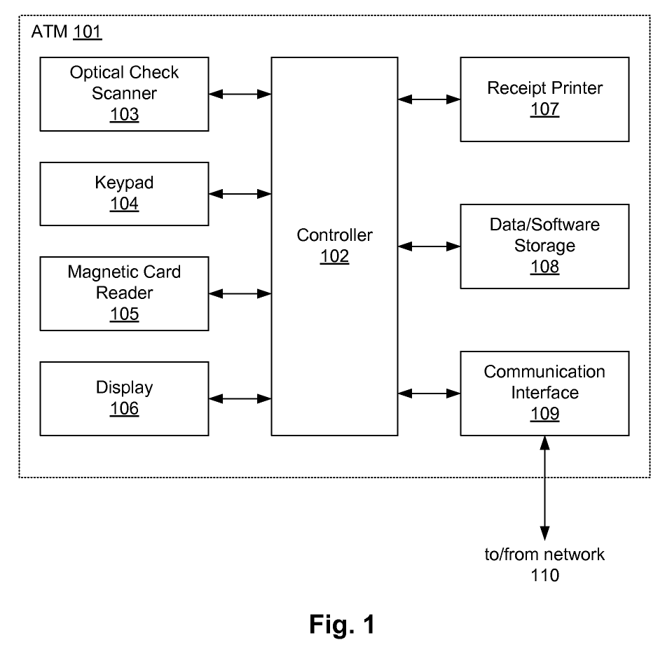

FIG. 1 shows a functional block diagram of an illustrative automated teller machine (ATM) 101 having optical check scanning functionality. Such an ATM is also referred to herein as an image ATM. In this particular example, image ATM 101 includes a controller 102, an optical check scanner 103, a keypad 104, a magnetic card reader 105, a display 106, a receipt printer 107, data/software storage 108, and a communication interface 109 coupled to a network 110 external to image ATM 101. Each of the blocks shown in FIG. 1 are merely for the explanatory purpose of indicating separate functions. However, the physical implementation may be divided in any manner desired regardless of function. For instance, controller 102 may be integrated or otherwise combined with communication interface 109 or physically separate from communication interface 109.

Controller 101 may be, for example, a processor such as a central processing unit (CPU), a computer, and/or any other circuitry configured to perform various functions as will be described herein. Controller 102 may be programmable by software stored as computer-executable instructions on data/software storage 108. Any or all actions by controller 102 may be attributed to steps instructed by the computer-executable instructions and/or by the hardware and/or firmware configuration inherent to controller 102.

Data/software storage 108 may be implemented as or otherwise include any computer-readable medium, such as one or more memories, caches, hard drives, removable storage discs (e.g., magnetic discs or optical discs), and/or tape drives. This computer-readable medium may store the software used to configure controller 102. This computer-readable medium may further store some or all of the data used by image ATM 101.

Keypad 104 may be any set of keys, such as number keys typically found on conventional ATMs. Magnetic card reader 105 may be any type of device that reads the magnetic strip on magnetic cards such as ATM/bank cards. Display 106 may be any type of display such as a cathode ray tube (CRT), liquid crystal display (LCD), or any other type of display. In some cases, where display 106 is coupled with or implemented as a touch-sensitive display, keypad 104 may be replaced or augmented with user-selectable soft keys displayed on display 106. Receipt printer 107 may be any printer that prints information to paper, such as text and/or graphics, including information regarding a financial transaction (e.g., deposit, withdrawal, or transfer) initiated at image ATM 101.

Communication interface 109 may be configured to communicate bi-directionally with network 110. For instance, communication interface 109 may include one or more modems for sending data to and receiving data from network 110. Network 110 may be any one or more networks, such as a land line telephone network, a cellular telephone network, a satellite network, and/or the Internet. As will be described later, network 110 allows image ATM 101 to communicate with a computer system that may be located anywhere, including a location that is geographically distant from image ATM 101, even in another country or continent. Network 110 may be configured to transfer data between image ATM 101 and the external computer system quickly enough such that data transfers may be completed within the expected timeframe of a typical ATM financial transaction, e.g., on the order of a few seconds or less than a minute or two.

Optical check scanner 103 may include, for instance, a camera that is able to take a digital photograph of the check to produce one or more images representing the front and/or back of the check. In addition to generating an image of the check, optical check scanner 103 may be further capable of reading magnetically printed information on the check, such as magnetic ink that is typically printed on a check, and performing magnetic ink character recognition (MICR). Such MICR processes are well known. The data produced by performing MICR that represents the recognized magnetic ink characters is referred to herein as MICR data.

As will be discussed further, image ATM 101 may be configured to implement a check deposit financial transaction in the following general manner. In addition to performing normal check processing functions, image ATM 101 may also optically scan a deposited check using optical check scanner 103. Then, data representing an image of the check, along with other data such as an identification of the account to which the check is to be deposited, is sent to the external computer system via communication interface 109 and network 110. In response, the external computer system analyzes the check image and determines whether there is any reason to place a hold on the check. If so, the system determines the amount of the hold and transmits this information back to image ATM 101 via network 110 and communication interface 109. Then, image ATM 101 is able to indicate to the customer what hold amount will be, via display 106 and/or receipt printer 107. All of this may be performed in real time during the check deposit transaction while the customer is still at image ATM 101. Thus, an instant hold notification may be provided by image ATM 101 to the customer, before the customer leaves.

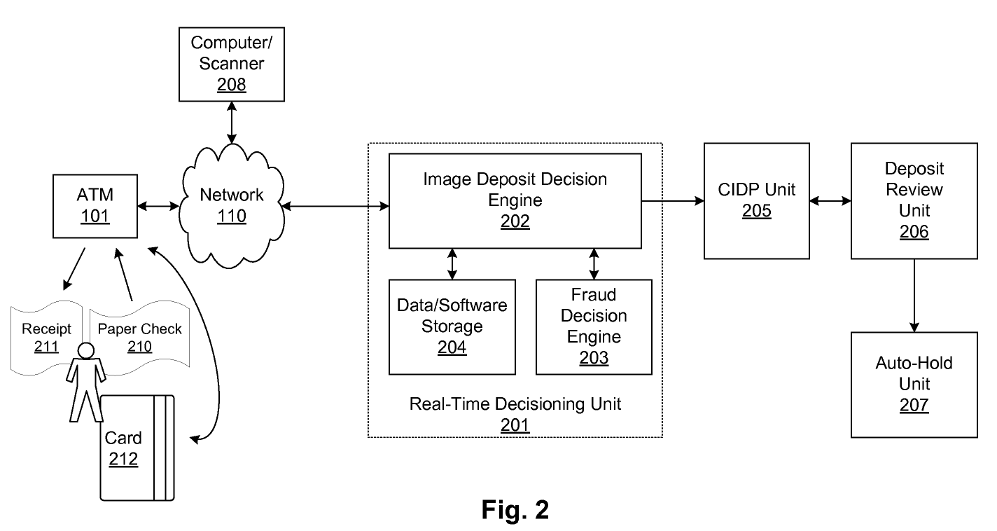

FIG. 2 is a functional block diagram of a system including image ATM 101. In this example, the external computer system referred to above includes a real-time decisioning unit 201, a centralized image deposit processing (CIDP) unit 205, a deposit review unit 206, and an auto-hold unit 207. In this example, real-time decisioning unit 201 includes an image deposit decision (IDD) engine 202, data/software storage 204, and a fraud decision engine 203. As in FIG. 1, each of the blocks shown in FIG. 2 are merely for the explanatory purpose of indicating separate functions. However, the physical implementation may be divided in any manner desired regardless of function. For example, any of the blocks 201-207 may be physically divided in the manner shown, or they may be integrated or otherwise combined with each other in any combination or sub-combination, as desired.

As also shown in FIG. 2, a customer may provide a magnetic card 212, such as an ATM/bank card, to image ATM 101, which may also be returned to the customer at the end of a financial transaction. The customer may also provide a paper check 210 for deposit to image ATM 101, and in return the customer may receive a paper receipt 211 indicating the status of the financial transaction including any hold time of the deposited check.

Each of blocks 201-203 and 205-207 may be implemented as one or more computers, such as servers, desktop computers, and/or laptop computers coupled together. Similarly to data/software storage 108, data/software storage 204 may be implemented as or otherwise include any computer-readable medium, such as one or more memories, caches, hard drives, removable storage discs (e.g., magnetic discs or optical discs), and/or tape drives. This computer-readable medium may store the software used to configure IDD engine 202. This computer-readable medium may further store some or all of the data used by IDD engine 202. In addition, any of the remaining blocks 201-203 and 205-207 may also have or otherwise have access to additional data/software storage, which may be either separate from data/software storage 204 or may share resources of data/software storage 204. Each of these blocks 201-203 and 205-207 may also be configurable by software stored in any of these data/software storage resources.

In a nutshell, the general functionality of the various blocks 201-203 and 205-206 in this example are as follows. Referring to transactions made from ATM 101, real-time decisioning unit 201 may receive check images from image ATM 101 via network 110, and using IDD engine 202, may determine based on at least the image whether any fraud and/or other properties are associated with the check being deposited. This may involve analyzing the image to ensure that the check is readable and that all appropriate fields are filled in, and/or comparing various information of the check with known fraudulent or otherwise problematic situations (e.g., the name of a suspected or known criminal is associated with the check). The data for this comparison may be stored in data/software storage 204.

Based on the analysis performed by fraud decision engine 202, IDD engine 202 may determine an amount of hold (e.g., which may be measured in the number of business days of hold) to be placed on the check. This hold time is sometimes also referred to as funds availability. Data representing this hold time amount is sent back to image ATM 101, which then proceeds to inform the customer of the hold time amount by displaying the hold time amount of display 106 and/or by printing the hold time amount on a receipt printed by receipt printer 107.

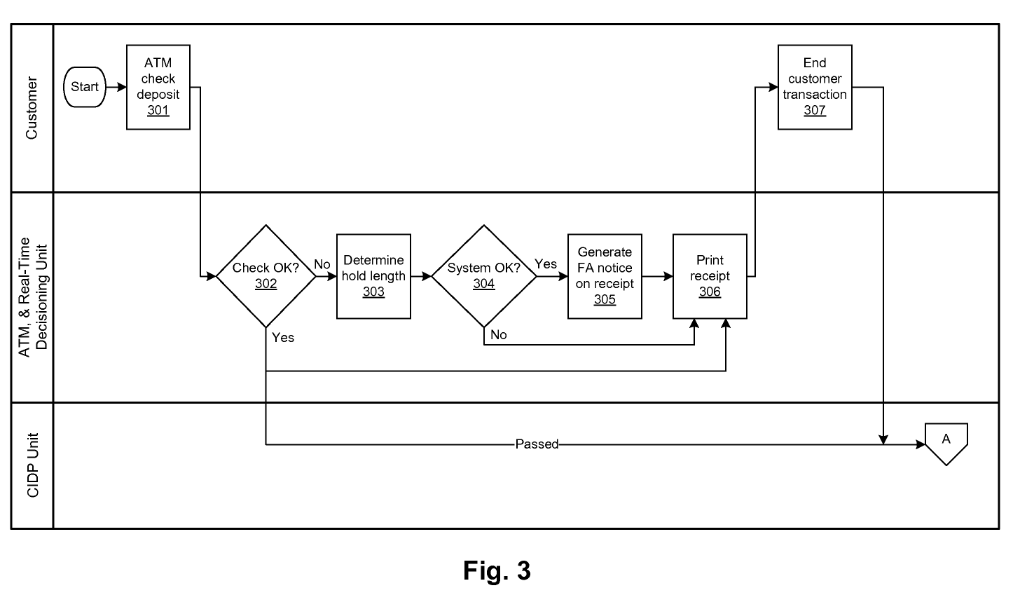

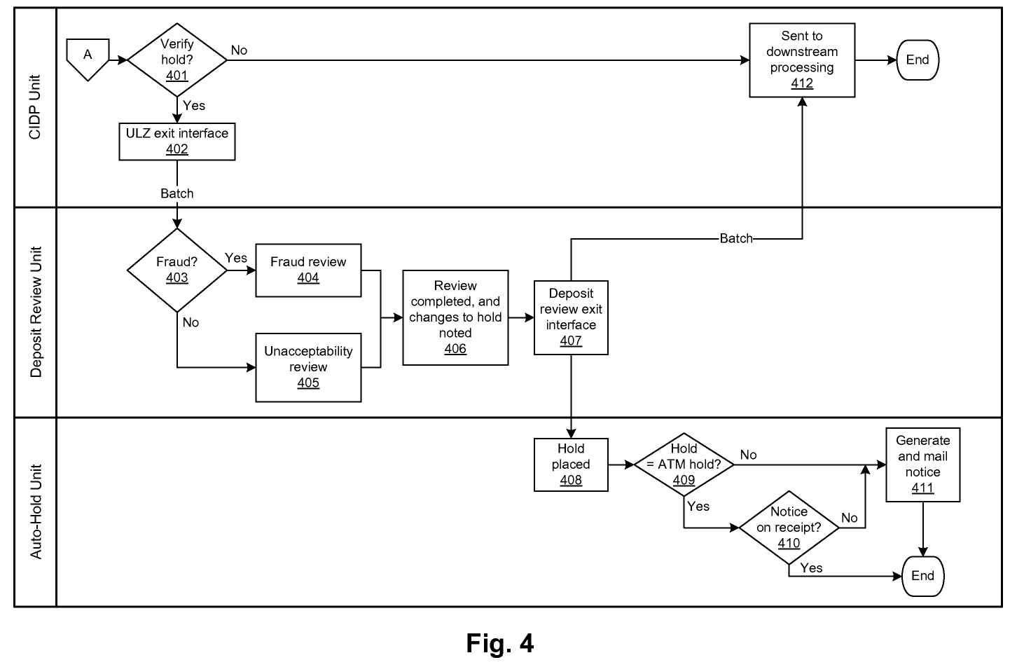

An illustrative operation of the system of FIG. 2 will be described in more detail with reference to the flowchart of FIGS. 3 and 4. This flowchart is divided into five zones, or swim lanes: Customer (referring to steps performed by the human customer), ATM and Real-Time Decisioning Unit (referring to steps performed by ATM 101 and/or real-time decisioning unit 201, CIDP Unit (referring to steps performed by CIDP unit 205), Deposit Review Unit (referring to steps performed by deposit review unit 206), and Auto-Hold Unit (referring to steps performed by auto-hold unit 207). The division of the various steps among the various zones is merely illustrative, and variations on this division may be made as desired.

Referring specifically to FIG. 3, the customer may begin a check deposit transaction (step 301) at ATM 101 by, for instance, inserting the customer's bank/ATM card 212 into magnetic card reader 105. ATM 101 may read the information magnetically encoded on the bank/ATM card and determine the account associated with the card. Following instructions that may be provided on display 106, the customer may insert paper check 210 to be deposited into that account into a slot of ATM 101 such that check 210 is fed to or otherwise received by optical check scanner 103.

In step 302, ATM 101 and/or real-time decisioning unit 201 determines whether the check meets one or more criteria for depositing without a funds availability hold time. In doing so, the decision may rely on one or more data points obtained from the scanned check and/or from other information. For example, the scanned image of check 210 may be reviewed to determine whether any check fields are missing or appear inappropriate. These check fields may include, for example, the signature line, the amount line, the payee line, and/or the date line. If any fields are missing or do not look right, then the result of step 302 may be “no,” meaning that the process would move to step 303 to determine the length of the hold time.

Another example of a data point that may affect the outcome of the step 302 determination is where the signature on the signature line of check 210 may be read and compared with a database of known fraudulent or otherwise problematic signatures and/or names. This database may be stored in, for instance, data/software storage 204. If there is a match, then the outcome of step 302 may be “no.” The same analysis may be performed for the endorsement on the back of the check, as well. For instance, real-time decisioning unit 201 may read the front image of the check to determine that there are two payees, and may also read the back image of the check to determine that there is only one endorsement. This may raise a red flag and cause the outcome of step 302 to be “no.” Or, the endorsement may be determined not match the payee or not to match a known signature of the endorser stored in data/software storage 204. In this case as well, this may cause the outcome of step 302 to be “no.”

Another example of a data point that may affect the outcome of the step 302 determination is where the account identification printed on check 210 (e.g., which may be obtained from check image analysis and/or from MICR data produced by optical check scanner 103) is compared with a database of known fraudulent or otherwise problematic accounts. This database also may be stored in, for instance, data/software storage 204. If there is a match, then the outcome of step 302 may be “no.”

The above are simply examples. There are many other possible ways of analyzing the image and/or MICR data of scanned check 210 to determine whether there is a sufficiently high amount of risk involved in connection with the check, such that the deposit for check 210 should be placed on hold. Many methods of risk assessment are known in the context of a teller check deposit transaction—that is, a check deposit performed before a human bank teller. However, these risk assessment methods have required the human teller to visually appraise the check and manually enter information about the check into a teller fraud detection system. While this is done in real time, such a real-time risk assessment has not been previously possible at the ATM. In the present example of FIGS. 3-4, by the time the customer has completed the check deposit transaction, the customer should be able to walk away from ATM 101 knowing whether check 210 is being placed on hold, and/or for how long the hold is to last.

Typically, a check deposit transaction at an ATM does not take long—on the order of a few seconds to less than a minute or two. Therefore, this risk assessment may be performed on a check-by-check basis in real time, rather than in a check batch process. To accomplish this, ATM 101 may send the one or more images of check 210 to be deposited, and/or any MICR and/or other data, to real-time decisioning unit 201 via network 110, while the customer transaction is occurring. Before the customer transaction is completed, real-time decisioning unit may provide information back to ATM 101, via network 110, indicating whether a hold is being placed on the check and/or how long the hold will be. Thus, real-time decisioning unit 201 may have real-time access to information needed for this assessment, such as data stored in data/software storage 204 representing known fraudulent or otherwise problematic accounts and/or signatures. IDD engine 202 may cause this assessment to be performed by referring to such stored data and also to fraud decision engine 203, which may actually perform the fraud detection function. Additionally or alternatively, some or all of the risk assessment may be performed directly by ATM 101, however because the risk assessment may require substantially more processing power than can be economically provided to ATM 101, it may be desirable for most if not all of the risk assessment analysis to be performed outside of ATM 101, such as by fraud decision engine 202.

Referring again to FIG. 3, if the outcome of step 302 is “yes,” (i.e., if it is determined that there is sufficiently low risk associated with the check deposit such that a hold does not need to be placed), then an indication of no hold may be presented on display 106 and/or printed on paper receipt 211 by receipt printer 107 (step 306). Then, the customer transaction may end at step 307. At this point, either before or after the printing of receipt 211, the customer's bank/ATM card 212 may be expelled from ATM 101 and thus returned to the customer.

If the outcome of step 302 is “no,” (i.e., if it is determined that there is sufficiently high risk associated with the check deposit such that a hold should be placed), then the length of the hold time may be determined in step 303 by IDD engine 202. Data representing the hold time is then sent to ATM 101 via network 110, which is then stored in data/software storage 108 for future use during the transaction.

Next, ATM 101 may determine in step 304 whether the system is working properly such that the hold time amount data has been successfully received by ATM 101 and/or the receipt printer is working properly. If so, then an indication of the hold being placed and/or the length of the hold (e.g., in days) may be generated in step 305 and presented on display 106 and/or printed on paper receipt 211 by receipt printer 107 (step 306). However, if the system is not working properly such that the hold time amount cannot be printed on receipt 211, then receipt 211 is simply printed in step 306 without the indication of the amount of hold time. Then, the customer transaction may end in step 307 as previously discussed.

In addition to sending data to real-time decisioning unit 201 about the scanned check and/or the account information read from the ATM/bank card, ATM 101 may further send data to real-time decisioning unit 201, or elsewhere, indicating an outcome of the customer transaction. For instance, ATM 101 may send to real-time decisioning unit 201, or elsewhere, a flag or other data indicating whether the amount of hold time was printed on receipt 211. As will be seen, this information may be used later to determine whether to send a hold notification to the customer, such as via the United States Postal Service, via a private courier, or electronically such as via email.

As shown in FIG. 3, after the end of the customer transaction, the process is passed to CIDP unit 205 in this example, which performs steps 401, 402, and 412. All steps performed in FIG. 3 in this example may be performed in real time, e.g., during the image deposit transaction. All steps performed in FIG. 4 in this example are less time-sensitive and therefore may be performed at any time during and/or after the image deposit transaction.

In the present example, CIDP unit 205 receives some or all of the data associated with the check deposit transaction from real-time decisioning unit 201. In step 401, CIDP unit 205 then verifies whether the hold amount determination by real-time decisioning unit 201 is correct. If the hold amount does not appear to be correct, or if there is sufficient doubt, then the information is sent to downstream processing (step 412) for further analysis.

If the hold amount is verified as being correct, then in step 402 the check data is batched with other check data and made available to deposit review unit 206. In step 403, deposit review unit 206 determines whether the hold was placed due to fraud or due to some other problem, such as a missing field on check 210. Data representing the reason for the hold may be generated by real-time decisioning unit 201, stored in data/software storage 204, and made available to deposit review unit 206. If the hold was placed due to fraud, then an additional fraud review is performed in step 404. This may include human review of the data associated with the check deposit. If the hold was placed due to a reason other than fraud, then an unacceptability review is performed in step 405. This may also include human review of the data associated with the check deposit. Either of steps 404 or 405 may result in a change being made to the funds availability hold time.

Next, in step 406, the fraud and unacceptability review is completed, and any changes to the hold time are noted by revising existing check transaction data or adding check transaction data. In step 407, the data is batched and made available to downstream processing for further standard check deposit transaction processes. In addition, the data is made available to auto-hold unit 207.

In step 408, auto-hold unit 207 actually places the hold on the check, which as stated previously may have been revised in steps 404-406. In step 409, auto-hold unit 207 determines whether the original hold time is equal to the hold time actually placed in step 408. If the two times are equal (i.e., if the originally determined hold time was not revised), then auto-hold unit 207 further determines in step 410 whether the hold time was printed on receipt 211 (using the transaction outcome data generated by ATM 101). If the hold time was printed on receipt 211, then the customer was adequately notified of the hold time, and this process stream ends (although the additional downstream processing referred to in step 412 may continue to occur).

If the hold time was not printed on receipt 211, then in step 411 auto-hold unit 207 causes a notice to be provided to the customer including an indication of the hold time. This notice may be a paper notice mailed to the customer such as via the United States Postal Service or a private courier, or provided electronically such as via email. This notice is provided in step 411 so that the customer has adequate notice of the correct hold time. If in step 409 it is determined that the hold time actually placed is not equal to the originally determined hold time, then in step 411 auto-hold unit 207 again causes the notice to be provided to the customer in step 411.

The process of FIGS. 3 and 4 may also be performed for an image deposit made from a location other than an ATM, substituting the other location for ATM in FIGS. 3 and 4. For example, a bank customer may own or otherwise have access to a computer 208 (FIG. 2) with a scanner and possibly also a printer. Computer 208 along with this equipment may be configured to produce optical images and/or MICR information from scanned checks at the customer's location. The computer 208 may interact with real-time decisioning unit 201 in the same way as ATM 101. In this case, the computer 208 may not utilize a scanner for card 212 and instead may authenticate the user and image deposit based on, for instance, a user ID and correlated password. The customer at computer 208 may be an individual or an organization, and may provide individual items for deposit one at a time or may upload a batch of items for processing as an image deposit. Thus, the real-time notification and fraud detection functionality may be portable among any image deposit channel, and not just limited to the ATM channel.

Thus, illustrative processes and systems have been described that provide for instant check deposit hold notifications and/or real-time fraud detection in connection with check image deposits.

1. A method, comprising:
receiving a paper check at an automated teller machine (ATM);
indicating to a user at the ATM an amount of hold time of the check, the amount of hold time being based on the check.

2. The method of claim 1, further comprising receiving from a source outside the ATM an indication of the amount of hold time.

3. The method of claim 1, further comprising scanning the check to obtain an image of the check.

4. The method of claim 3, further comprising:
sending data representing the image of the check to a network outside the ATM; and
receiving an indication of the amount of hold time from the network.

5. The method of claim 3, further comprising determining the amount of hold time based on the image of the check.

6. The method of claim 1, wherein indicating is performed during an ATM transaction of depositing the check.

7. The method of claim 1, wherein indicating comprises printing a paper receipt at the ATM including an indication of both an amount of the check and the amount of hold time.

8. The method of claim 1, further comprising:
receiving a magnetic card; and
expelling the magnetic card,
wherein indicating is performed prior to expelling the magnetic card.

9. A method, comprising:
receiving first data representing an image deposit including an image of a check;
determining a first amount of a hold time of the check based on the image; and
generating second data representing the amount of hold time.

10. The method of claim 9, wherein receiving comprises receiving the first data from an automated teller machine (ATM), and the method further comprises sending the second data to the ATM.

11. The method of claim 10, wherein sending the second data is performed during an ATM transaction of depositing the check.

12. The method of claim 10, further comprising:
receiving third data from the ATM representing whether an indication of the first amount of hold time was printed on a paper receipt; and
responsive to the third data representing that the indication of the first amount of hold time was not printed on a paper receipt, generating a paper notice indicating the first amount of hold time.

13. The method of claim 12, further comprising sending the paper notice to an address associated with an account into which the check is to be deposited.

14. The method of claim 9, further comprising:
determining a second amount of hold time of the check;
comparing the second amount of hold time with the first amount of hold time; and
responsive to determining that the second amount of hold time is different from the first amount of hold time, generating a paper notice indicating the second amount of hold time.

15. The method of claim 14, further comprising sending the paper notice to an address associated with an account into which the check is to be deposited.

16. An apparatus, comprising;
a user output device;
a scanner configured to generate an image by scanning a paper check;
a communication interface configured to communicate with a network external to the apparatus; and
a controller configured to cause the communication interface to send to the network first data representing the image and to receive from the network second data representing an amount of hold time of the check, and to cause the user output device to indicate the amount of hold time.

17. The apparatus of claim 16, further comprising a card reader configured to read information identifying an account from a magnetic card, wherein the controller is further configured to cause the communication interface to send to the network third data identifying the account.

18. The apparatus of claim 16, wherein the scanner is further configured to magnetically read magnetic ink characters printed on the check, and the controller is further configured to cause the communication interface to send third data representing the magnetically read characters.

19. A computer-readable medium storing computer-executable instructions for performing a method, the method comprising:
sending to a network first data representing an image of a paper check;
receiving from the network second data representing an amount of hold time of the check; and
causing an indication of the amount of hold time to be presented by a user output device.

20. The computer-readable medium of claim 19, wherein the method further comprises:
causing a card reader to read information stored on a magnetic card; and
causing the card reader to expel the magnetic card,
wherein causing the indication to be presented is performed prior to causing the card reader to expel the magnetic card.
